(19) United States
(12) Patent Application Publication
(10) Pub. No.: US 2020/0186000 A1
(43) Pub. Date: Jun. 11, 2020

(54) MOTOR AND PUMP DEVICE

(71) Applicant: NIDEC SANKYO CORPORATION, Suwa-gun, Nagano (JP)

(72) Inventors: Nobuki KOKUBO, Suwa-gun, Nagano (JP); Takashi YAMAMOTO, Suwa-gun, Nagano (JP)

(21) Appl. No.: 16/312,429

(22) PCT Filed: Jun. 7, 2017
(86) PCT No.: PCT/JP2017/021097

§ 371 Date: Dec. 21, 2018

(30) Foreign Application Priority Data
Jun. 24, 2016 (JP) 2016-125819

(51) Int. Cl. H02K 5/22; H02K 1/04; H02K 29/08

(52) U.S. Cl. CPC H02K 5/225; H02K 29/08; H02K 1/04

(57) ABSTRACT

A motor may include a rotor having a drive magnet; a stator having a drive coil; a partition member between the rotor and stator; a circuit board fixed to the partition; and a magnetic sensor oppositely disposed to an outer face of the drive magnet through the partition. The stator may include an insulation member; and a stator core having salient pole parts. The stator core may include a ring part; and the salient pole part. The insulation member may include an inner flange part. The partition may include a cylindrical tube part, and a bottom part. A first direction end of an outer face of the partition may include an inclined face. The inner flange part may include a positioning part. A terminal of the magnetic sensor may be mounted on the circuit board. The magneto-sensitive part may be disposed between the cylindrical tube part and the positioning part.

### CROSS REFERENCE TO RELATED APPLICATIONS

This is the U.S. national stage of application No. PCT/JP2017/021097, filed on Jun. 7, 2017. Priority under 35 U.S.C. § 119(a) and 35 U.S.C. § 365(b) is claimed from Japanese Application No. 2016-125819, filed Jun. 24, 2016; the disclosures of which are incorporated herein by reference.

### FIELD OF THE INVENTION

At least an embodiment of the present invention relates to a motor having a partition which is disposed between a rotor and a stator. Further, at least an embodiment of the present invention relates to a pump device including the motor.

### BACKGROUND

Conventionally, a pump device has been known which includes a pump chamber in which an impeller and a rotor are disposed and a stator and a circuit board which are disposed on an outer side of the pump chamber (see, for example, Patent Literature 1). In the pump device described in Patent Literature 1, a partition which prevents an inflow of a fluid to an arrangement portion of the stator and the circuit board is disposed between the stator, the circuit board and the pump chamber. The rotor includes a drive magnet. The stator is formed in a substantially cylindrical tube shape and includes drive coils and a stator core around which the drive coils are wound through insulation members. The stator core is provided with a circular ring part in a circular ring shape and a plurality of salient pole parts which are protruded from the circular ring part to an inner side in a radial direction of the rotor. The insulation member is structured of an inner side insulation part disposed on an inner side in the radial direction of the rotor, an outer side insulation part disposed on an outer side in the radial direction, and a connecting insulation part which connects the inner side insulation part and the outer side insulation part. The partition is formed in a bottomed cylindrical tube shape.

Further, in the pump device described in Patent Literature 1, a circuit board is formed in a flat plate shape and is fixed to a bottom part of the partition so that an axial direction of the stator and a thickness direction of the circuit board are coincided with each other. Magnetic sensors having magneto-sensitive parts which are oppositely disposed to an outer peripheral face of the drive magnet through the partition are mounted on the circuit board. Specifically, terminals of the magnetic sensor are mounted on the circuit board so that its magneto-sensitive part is protruded from the circuit board, and the magneto-sensitive part is disposed between end faces of the inner side insulation parts adjacent to each other in a circumferential direction of the rotor. In the pump device according to Patent Literature 1, a three-phase brushless motor is structured of the rotor and the stator. Further, the magnetic sensor functions to detect a rotational position of the rotor by detecting magnetic poles of the outer peripheral face of the drive magnet, and electric currents supplied to the drive coils are controlled based on detected results by the magnetic sensors.

### CITATION LIST

[PTL 1] Japanese Patent Laid-Open No. 2012-92736

In the pump device described in Patent Literature 1, the magneto-sensitive part of the magnetic sensor for detecting magnetic poles of the outer peripheral face of the drive magnet is oppositely faced to the outer peripheral face of the drive magnet through the partition, and a distance between the outer peripheral face of the drive magnet and the magneto-sensitive part is increased by a thickness of the partition. Therefore, in the pump device, when an arrangement position of the magneto-sensitive part is displaced to an outer side in the radial direction of the rotor and a distance between the outer peripheral face of the drive magnet and the magneto-sensitive part becomes further larger, the magnetic poles of the outer peripheral face of the drive magnet may be difficult to be appropriately detected by the magnetic sensor.

### SUMMARY

In view of the problem described above, at least an embodiment of the present invention provides a motor having a partition disposed between a rotor and a stator, in which a relative positional accuracy in a radial direction between a magneto-sensitive part of a magnetic sensor which is oppositely disposed to an outer peripheral face of a drive magnet of the rotor through a partition and the drive magnet is capable of being enhanced. Further, at least an embodiment of the present invention provides a pump device including the motor.

To achieve the above mentioned objective, at least an embodiment of the present invention provides a motor including a rotor having a drive magnet, a stator which includes a drive coil and is disposed on an outer peripheral side with respect to the rotor, a partition member having a partition in a substantially bottomed cylindrical tube shape which is disposed between the rotor and the stator, a circuit board fixed to the partition on an outer side of the partition in an axial direction of the rotor, and a magnetic sensor having a magneto-sensitive part which is oppositely disposed to an outer peripheral face of the drive magnet through the partition. When a direction where the circuit board is disposed to the partition in the axial direction is referred to as a first direction and an opposite direction to the first direction is referred to as a second direction, the stator includes an insulation member and a stator core having a plurality of salient pole parts around each of which the drive coil is wound through the insulation member. The stator core is provided with an outer peripheral ring part which is formed in a ring shape and the plurality of the salient pole parts which are protruded from the outer peripheral ring part to an inner side in a radial direction of the rotor, and the insulation member is provided with an inner side flange part which structures an inner side portion in the radial direction of the insulation member. The partition is provided with a cylindrical tube part in a cylindrical tube shape, which is disposed between the rotor and the stator, and a bottom part in a circular plate shape which closes a first direction end of the cylindrical tube part and to which the circuit board is fixed. A first direction end of an outer peripheral face of the partition is formed with an inclined face whose outer diameter is gradually decreased as going to a first direction side, the inner side flange part is provided with a positioning part which restricts a position of the magneto-sensitive part in the radial direction, a terminal of the magnetic sensor is mounted on the circuit board so that the magneto-sensitive part is protruded from the circuit board to a second direction side, and the magneto-sensitive part is disposed between the cylindrical tube part and the positioning part in the radial direction.

In the motor in accordance with at least an embodiment of the present invention, the partition is provided with a cylindrical tube part in a cylindrical tube shape, which is disposed between the rotor and the stator, and a bottom part in a circular plate shape which closes a first direction end of the cylindrical tube part and to which the circuit board is fixed, and a terminal of the magnetic sensor is mounted on the circuit board so that the magneto-sensitive part of the magnetic sensor which is oppositely disposed to the outer peripheral face of the drive magnet through the partition is protruded to a second direction side. Further, in at least an embodiment of the present invention, an inclined face whose outer diameter is gradually decreased as going to the first direction side is formed at a first direction end of the outer peripheral face of the partition. Therefore, according to at least an embodiment of the present invention, when the circuit board on which the magnetic sensor is mounted is to be fixed to the bottom part of the partition from the first direction side, the magneto-sensitive part can be smoothly guided to the outer peripheral side of the cylindrical tube part by utilizing the inclined face of the partition while preventing excessive bending of the terminal of the magnetic sensor.

Further, in at least an embodiment of the present invention, the inner side flange part structuring an inner side portion of the insulation member in the radial direction is provided with a positioning part which restricts a position of the magneto-sensitive part in the radial direction, and the magneto-sensitive part is disposed between the cylindrical tube part and the positioning part in the radial direction. Therefore, according to at least an embodiment of the present invention, the magneto-sensitive part which is guided to the outer peripheral side of the cylindrical tube part by utilizing the inclined face of the partition can be positioned by the outer peripheral face of the cylindrical tube part and the positioning part with a high degree of accuracy in the radial direction. Accordingly, in at least an embodiment of the present invention, a relative positional accuracy in the radial direction between the magneto-sensitive part of the magnetic sensor oppositely disposed to the outer peripheral face of the drive magnet through the partition and the drive magnet can be enhanced.

In at least an embodiment of the present invention, a width in a circumferential direction of the rotor of an inner side face of the positioning part in the radial direction is set to be wider than a width of the magneto-sensitive part in the circumferential direction. According to this structure, a relative position in the circumferential direction of the magneto-sensitive part to the stator can be shifted depending on characteristics or the like of the motor. Therefore, a common insulation member can be used in motors whose characteristics are different from each other and, as a result, versatility of the insulation member can be enhanced.

In at least an embodiment of the present invention, the inner side face of the positioning part in the radial direction is formed in a curved surface shape whose shape when viewed in the axial direction is a circular arc shape with a rotation center of the rotor as a center of curvature. According to this structure, even when a relative position in the circumferential direction of the magneto-sensitive part to the stator can be shifted depending on characteristics or the like of the motor, displacement of a relative position in the radial direction between the magneto-sensitive part and the drive magnet is restrained and a relative positional accuracy in the radial direction of the magneto-sensitive part to the drive magnet can be enhanced.

In at least an embodiment of the present invention, a chamfer part is formed at an inner side end in the radial direction of an end face on the first direction side of the positioning part. Further, in at least an embodiment of the present invention, an inner side face of the positioning part in the radial direction is formed to be an inclined face which is inclined to an inner side in the radial direction as going to a second direction side. According to this structure, when the circuit board on which the magnetic sensor is mounted is to be fixed to the bottom part of the partition from the first direction side, the magneto-sensitive part is easily entered between the cylindrical tube part and the positioning part in the radial direction.

In at least an embodiment of the present invention, for example, the inner side flange part is formed in a flat plate shape which is perpendicular to the radial direction, and the positioning part is provided with a protruded part which is protruded from an inner side face of the inner side flange part in the radial direction. In this case, for example, in comparison with a case that the inner side flange part is formed in a curved plate shape, the inner side flange part can be formed easily. Further, in this case, even when the inner side flange part is formed in a flat plate shape, a position of the magneto-sensitive part in the radial direction can be restricted by utilizing the protruded part.

In at least an embodiment of the present invention, for example, an end face on the first direction side of the protruded part is disposed on the same plane as an end face on the first direction side of the inner side flange part.

In at least an embodiment of the present invention, a chamfer part is formed at an inner side end in the radial direction of an end face on a second direction side of the magneto-sensitive part. According to this structure, when the circuit board on which the magnetic sensor is mounted is to be fixed to the bottom part of the partition from the first direction side, the magneto-sensitive part is easily entered between the cylindrical tube part and the positioning part in the radial direction.

In at least an embodiment of the present invention, the terminal urges the magneto-sensitive part to an inner side in the radial direction, and the magneto-sensitive part is contacted with an outer peripheral face of the cylindrical tube part.

In at least an embodiment of the present invention, the positioning part is formed with a recessed part which is recessed from an inner side face of the inner side flange part in the radial direction.

In at least an embodiment of the present invention, a face on the first direction side of the bottom part is formed with a positioning protruded part configured to position the circuit board fixed to the partition member so as to be protruded to the first direction side.

In at least an embodiment of the present invention, the partition member is provided with an outer tube part in a tube shape disposed on an outer peripheral side with respect to the partition and a bottom face part which connects a lower end of the cylindrical tube part and a lower end of the outer tube part, the bottom face part is formed with a columnar protruded part which is stood up to an upper side, and a circuit board positioning part configured to position the circuit board together with the positioning protruded part is formed on a tip end part side of the protruded part.

In at least an embodiment of the present invention, the stator core is provided with three salient pole parts, the three salient pole parts are formed at equal angular pitches and are disposed at equal intervals in a circumferential direction, the stator includes three insulation members each of which is attached to each of the three salient pole parts and three drive coils each of which is wound around each of the three salient pole parts through each of the three insulation members. The three insulation members are provided with three inner side flange parts each of which is formed in each of the three insulation members, the three inner side flange parts are provided with three positioning parts each of which is formed in each of the three inner side flange parts, and the three positioning parts include three magnetic sensors each of which is disposed in each of the three positioning parts.

The motor in accordance with at least an embodiment of the present invention may be used in a pump device which includes an impeller attached to the rotor and in which a part of a pump chamber where the impeller is disposed and a fluid is passed through is defined by the partition member. In the pump device, a relative positional accuracy in the radial direction between the magneto-sensitive part of the magnetic sensor oppositely disposed to the outer peripheral face of the drive magnet through the partition and the drive magnet can be enhanced.

As described above, in at least an embodiment of the present invention, a relative positional accuracy in the radial direction between the magneto-sensitive part of the magnetic sensor oppositely disposed to the outer peripheral face of the drive magnet through the partition and the drive magnet can be enhanced.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing a pump device in accordance with an embodiment of the present invention.

FIG. 2 is a perspective view showing a stator, a partition member and magnetic sensors shown in FIG. 1.

FIG. 3 is a perspective view showing the magnetic sensor and an insulator in FIG. 2.

FIGS. 4(A) and 4(B) are explanatory views showing a fixing method of a circuit board to a partition shown in FIG. 1.

FIG. 5 is an explanatory perspective view showing a structure of a positioning part in accordance with another embodiment of the present invention.

FIG. 6 is an explanatory cross-sectional view showing a structure of a positioning part in accordance with another embodiment of the present invention.

### DETAILED DESCRIPTION

At least an embodiment of the present invention will be described below with reference to the accompanying drawings.

### (Entire Structure of Pump Device)

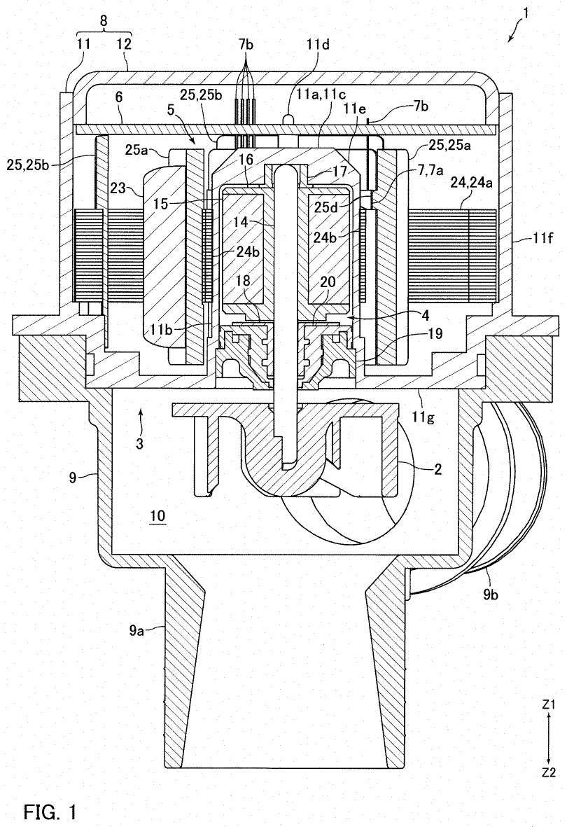

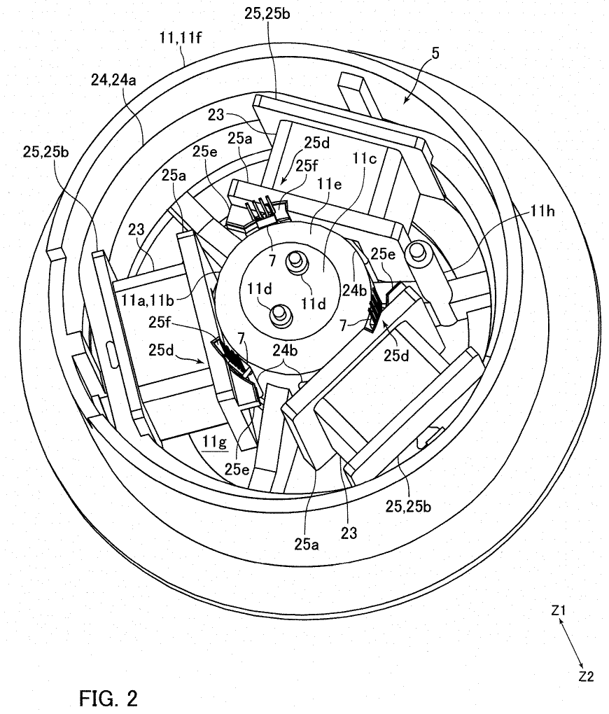

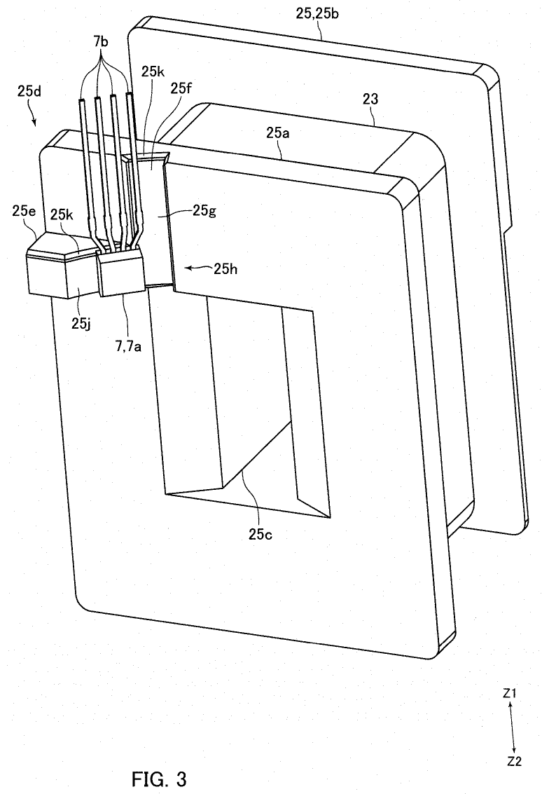

FIG. 1 is a cross-sectional view showing a pump device 1 in accordance with an embodiment of the present invention. FIG. 2 is a perspective view showing a stator 5, a partition member 11 and magnetic sensors 7 shown in FIG. 1. FIG. 3 is a perspective view showing the magnetic sensor 7 and an insulator 25 in FIG. 2. In the following descriptions, an upper side (“Z1” direction side) in FIG. 1 is referred to as an “upper” side, and a lower side (“Z2” direction side) in FIG. 1 is referred to as a “lower” side.

A pump device 1 in this embodiment is a pump referred to as a canned pump (canned motor pump) and includes an impeller 2 and a motor 3 structured to rotate the impeller 2. The motor 3 is a three-phase brushless motor. The motor 3 includes a rotor 4, a stator 5, a circuit board 6 configured to control the motor 3, and magnetic sensors 7 structured to detect a rotational position of the rotor 4. The impeller 2, the rotor 4, the stator 5, the circuit board 6 and the magnetic sensors 7 are disposed in an inside of a case body which is structured of a housing 8 structuring a part of the motor 3 and a case 9 covering a lower part of the housing 8. The housing 8 and the case 9 are fixed to each other with a screw not shown.

The case 9 is formed with a suction part 9a for a fluid and a discharge part 9b for the fluid. An inside of the case 9 is formed with a pump chamber 10 through which a fluid sucked through the suction part 9a is passed toward the discharge part 9b. The housing 8 includes a partition member 11 provided with a partition 11a, which is disposed between the rotor 4 and the stator 5 so as to separate the rotor 4 from the stator 5, and a cover 12 which is fixed to an upper end side of the partition member 11.

The rotor 4 includes a rotation shaft 14 and a drive magnet 15. The rotation shaft 14 is disposed so that an axial direction of the rotation shaft 14 and the upper and lower direction are coincided with each other. In other words, the upper and lower direction is the axial direction of the rotor 4. The drive magnet 15 is formed in a cylindrical tube shape. The drive magnet 15 is fixed to an outer peripheral face of the rotation shaft 14 through a magnet holding member 16. An outer peripheral face of the drive magnet 15 is alternately magnetized with an “N”-pole and an “S”-pole in a circumferential direction of the drive magnet 15. In this embodiment, two magnetic poles, i.e., one “N”-pole and one “S”-pole are magnetized on the outer peripheral face of the drive magnet 15.

The impeller 2 is fixed to a lower end part of the rotation shaft 14. In other words, the impeller 2 is attached to the rotor 4. The impeller 2 is disposed in the inside of the pump chamber 10. An upper end side of the rotation shaft 14 is rotatably held by a bearing 17. The bearing 17 is fixed to an upper end side of the partition 11a. A lower end side of the rotation shaft 14 is rotatably held by a bearing 18. The bearing 18 is held by a bearing holding member 19 which is fixed to a lower end side of the partition 11a. A seal member 20 made of rubber structured to prevent an inflow of a fluid to an arrangement portion of the drive magnet 15 is disposed between the bearing 18 and the bearing holding member 19.

The stator 5 includes drive coils 23, a stator core 24 and insulators 25 as an insulation member, and is formed in a tube shape as a whole. The stator 5 is disposed on an outer peripheral side with respect to the rotor 4 through the partition 11a. Further, the stator 5 is disposed so that an axial direction of the stator 5 formed in a tube shape and the upper and lower direction are coincided with each other. A specific structure of the stator 5 will be described below. In the following descriptions, radial directions of the rotor 4 and the stator 5 are referred to as a “radial direction”, and circumferential directions of the rotor 4 and the stator 5 (circumferential direction) are referred to as a “circumferential direction”.

As described above, the partition member 11 is provided with the partition 11a. The partition 11a is formed in a substantially bottomed cylindrical tube shape and is provided with a cylindrical tube part 11b and a bottom part 11c. The cylindrical tube part 11b is formed in a cylindrical tube shape. The cylindrical tube part 11b is disposed so as to cover the outer peripheral face of the drive magnet 15 and is disposed between the rotor 4 and the stator 5 in the radial direction. The bottom part 11c is formed in a circular plate shape which closes an upper end of the cylindrical tube part 11b. The bearing 17 is fixed to an under face of the bottom part 11c, and the bearing holding member 19 is fixed to a lower end side of an inner peripheral face of the cylindrical tube part 11b.

An upper face of the bottom part 11c is formed with positioning protruded parts 11d for positioning the circuit board 6 fixed to the partition member 11 so as to be protruded to an upper side. In this embodiment, two positioning protruded parts 11d are formed on an upper face of the bottom part 11c. An upper end of the outer peripheral face of the partition 11a is formed with an inclined face 11e whose outer diameter gradually becomes smaller as going to the upper side. In other words, the upper end of the outer peripheral face of the partition 11a is formed with the taper-shaped inclined face 11e and an upper end side portion of the partition 11a is formed in a truncated cone shape.

Further, the partition member 11 is provided with a tube-shaped outer tube part 11f disposed on an outer peripheral side with respect to the partition 11a and a bottom face part 11g which connects the lower end of the cylindrical tube part 11b and a lower end of the outer tube part 11f. The outer tube part 11f is, for example, formed in a substantially cylindrical tube shape. A height (height in the upper and lower direction) of the outer tube part 11f is set to be higher than a height of the partition 11a. The stator 5 is disposed between the cylindrical tube part 11b and the outer tube part 11f in the radial direction.

The bottom face part 11g is formed in a circular ring shape. A lower side of the bottom face part 11g is structured to be the pump chamber 10, and a part of the pump chamber 10 is defined by the bottom face part 11g. In other words, a part of the pump chamber 10 is defined by the partition member 11. The bottom face part 11g functions to prevent an inflow of a fluid in the pump chamber 10 to an arrangement portion of the stator 5 and the circuit board 6. The bottom face part 11g is formed with a columnar protruded part 11h which is stood up toward an upper side (see FIG. 2), and a positioning part for positioning the circuit board 6 together with the positioning protruded parts 11d is formed on a tip end part side (upper end part) of the protruded part 11h. In other words, the tip end of the protruded part 11h is structured to be a circuit board positioning part. In FIG. 1, the protruded part 11h is not shown.

The circuit board 6 is a rigid board such as a glass epoxy substrate and is formed in a flat plate shape. The circuit board 6 is disposed on an upper side with respect to the drive coils 23, the stator core 24 and the insulators 25 so that a thickness direction of the circuit board 6 and the upper and lower direction are coincided with each other. Further, the circuit board 6 is disposed on a lower side with respect to the upper end of the outer tube part 11f. Further, the circuit board 6 is fixed to the bottom part 11c in a positioned state by the positioning protruded parts 11d and the like. In other words, the circuit board 6 is fixed to the partition 11a on an upper side with respect to the bottom part 11c (in other words, an outer side of the partition 11a in the upper and lower direction). An upper direction (“Z1” direction) in this embodiment is a first direction which is a direction where the circuit board 6 is disposed with respect to the partition 11a in the axial direction of the rotor 4, and a lower direction (“Z2” direction) is a second direction which is an opposite direction to the first direction.

The magnetic sensor 7 is a Hall element. The magnetic sensor 7 detects a magnetic pole of the outer peripheral face of the drive magnet 15 and functions to detect a rotational position of the rotor 4. As described above, the motor 3 is a three-phase DC brushless motor and the motor 3 includes three magnetic sensors 7. The magnetic sensor 7 includes a magneto-sensitive part 7a formed in a substantially rectangular solid shape and a plurality of terminals (lead) 7b which are extended from the magneto-sensitive part 7a. The magnetic sensor 7 is mounted on the circuit board 6. Specifically, the terminals 7b are mounted on the circuit board 6 so that the magneto-sensitive part 7a is protruded from the circuit board 6 to a lower side. Further, the three magnetic sensors 7 are mounted on the circuit board 6 so that, when viewed in the upper and lower direction, the three magnetic sensors 7 are disposed at a pitch of 120° with respect to a rotation center of the rotor 4. In accordance with an embodiment of the present invention, the magnetic sensor 7 may be a sensor other than a Hall element.

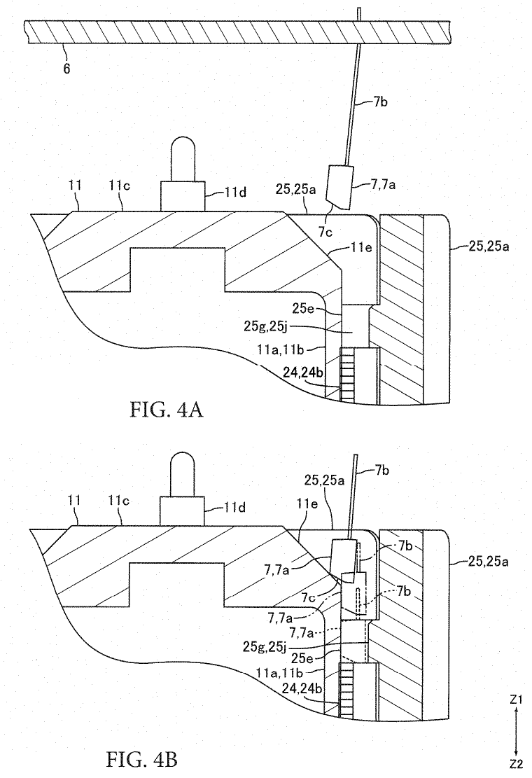

The magneto-sensitive part 7a is disposed so as to face the outer peripheral face of the drive magnet 15 through the partition 11a. Specifically, a magneto-sensitive face of the magneto-sensitive part 7a is oppositely disposed to the outer peripheral face of the drive magnet 15 through the cylindrical tube part 11b. Further, the magneto-sensitive part 7a is disposed in an upper end side portion of the cylindrical tube part 11b and, in addition, on an outer peripheral side in a lower portion with respect to the inclined face 11e. A chamfer part 7c is formed at an inner side end in the radial direction of a lower end face of the magneto-sensitive part 7a (see FIG. 4). In other words, an inner side end in the radial direction of the lower end face of the magneto-sensitive part 7a is formed to be an inclined face which is inclined to an upper side as going to an inner side in the radial direction.

The cover 12 is formed in a flat and substantially bottomed cylindrical tube shape. The cover 12 is fixed to an upper end side of an inner peripheral face of the outer tube part 11f and closes an opening of an upper end of the cover 12. In other words, the cover 12 covers the stator 5 and the circuit board 6 from an upper side, and the stator 5 and the circuit board 6 are disposed in a space defined by the cylindrical tube part 11b, the outer tube part 11f, the bottom face part 11g and the cover 12. In accordance with an embodiment of the present invention, a resin sealing member may be filled in an inside of a space defined by the cylindrical tube part 11b, the outer tube part 11f, the bottom face part 11g and the cover 12.

### (Structure of Stator)

As described above, the stator 5 includes the drive coils 23, the stator core 24 and the insulators 25. Further, the stator 5 includes terminal pins (not shown) with which end parts of the drive coils 23 are electrically connected. Lower end sides of the terminal pins are, for example, fixed to the insulator 25, and upper end sides of the terminal pins are soldered and fixed to the circuit board 6.

The stator core 24 is a lamination core which is formed by laminating thin magnetic plates made of magnetic material. The stator core 24 is provided with an outer peripheral ring part 24a formed in a ring shape and a plurality of salient pole parts 24b which are protruded from the outer peripheral ring part 24a to an inner side in the radial direction. The stator core 24 in this embodiment is provided with three salient pole parts 24b. The three salient pole parts 24b are formed at equal angular pitches and are disposed at constant intervals in a circumferential direction. A tip end portion of the salient pole part 24b is formed in a curved surface shape whose shape viewed in the upper and lower direction is a circular arc shape with a rotation center of the rotor 4 as a center of curvature.

The insulator 25 is formed of resin material having an insulation property. The insulator 25 is attached to each of the salient pole parts 24b, and the stator 5 includes three insulators 25. Further, the insulator 25 is formed in a tube shape with flanges which is provided with flange parts at both ends and is attached to the salient pole part 24b so that an axial direction of the insulator 25 formed in a tube shape and the radial direction of the stator 5 are coincided with each other. In other words, the insulator 25 is structured of an inner side flange part 25a structuring an inner side portion of the insulator 25 in the radial direction, an outer side flange part 25b structuring an outer side portion of the insulator 25 in the radial direction, and tube part 25c (see FIG. 3) which connects the inner side flange part 25a with the outer side flange part 25b.

The tube part 25c is formed in a rectangular tube shape. The drive coil 23 is wound around the tube part 25c. In other words, the drive coil 23 is wound around the salient pole part 24b through the insulator 25. Switching of energization to the drive coils 23 which are wound around three salient pole parts 24b is performed based on detected results of the magnetic sensors 7. Each of the inner side flange part 25a and the outer side flange part 25b is formed in a flat plate shape perpendicular to the radial direction and is formed in a rectangular ring shape. The inner side flange part 25a covers a tip end portion of the salient pole part 24b whose shape viewed in the upper and lower direction is a circular arc shape from an outer side in the radial direction. The outer side flange part 25b covers a part of the outer peripheral ring part 24a from an inner side in the radial direction. The inner side flange part 25a and the outer side flange part 25b function to prevent occurring winding collapse of the drive coil 23 which is wound around the tube part 25c.

The inner side flange part 25a is provided with a positioning part 25d configured to restrict a position of the magneto-sensitive part 7a in the radial direction. As shown in FIG. 3, the positioning part 25d is disposed on an upper end side of the inner side flange part 25a. Further, the positioning part 25d is disposed on one end side of the inner side flange part 25a in a circumferential direction. In other words, a corner part on the upper end side and one end side in the circumferential direction of the inner side flange part 25a is formed as the positioning part 25d. The positioning part 25d is provided with a protruded part 25e which is protruded from an inner side face of the inner side flange part 25a in the radial direction. Further, the positioning part 25d is formed with a recessed part 25f which is recessed from the inner side face of the inner side flange part 25a in the radial direction. In this case, when the recessed part 25f is formed, a portion in the circumferential direction of the positioning part 25d configured to restrict a position of the magneto-sensitive part 7a can be widened.

The protruded part 25e is formed so that a shape when viewed in the upper and lower direction is a substantially trapezoid shape. One end face of the protruded part 25e in the circumferential direction is disposed on the same plane as one end face of the inner side flange part 25a in the circumferential direction. An upper end face of the protruded part 25e is disposed on a lower side with respect to an upper end face of the inner side flange part 25a. A lower end face of the protruded part 25e is disposed on the same plane as an upper face of an inner peripheral face of the tube part 25c. The recessed part 25f is formed so that a shape viewed in the upper and lower direction is a substantially triangular shape. The recessed part 25f is formed between an upper end face of the inner side flange part 25a and a lower end face of the protruded part 25e in the upper and lower direction.

An inner side face 25g of the positioning part 25d in the radial direction is structured of an inner side face of the protruded part 25e in the radial direction and an inner side face of the recessed part 25f in the radial direction. The inner side face 25g is formed in a curved surface shape. Specifically, the inner side face 25g is formed in a curved surface shape whose shape when viewed in the upper and lower direction is a circular arc shape with the rotation center of the rotor 4 as the center of curvature. Further, the inner side face 25g is formed to be a perpendicular plane which is not inclined with respect to the upper and lower direction.

A width of the inner side face 25g in the circumferential direction is set to be wider than a width of the magneto-sensitive part 7a in the circumferential direction. Specifically, when a range of the positioning part 25d where the protruded part 25e is formed in the upper and lower direction is referred to as a lower end side positioning part 25h and, when an inner side face of the lower end side positioning part 25h in the radial direction (in other words, a range where the protruded part 25e is formed in the upper and lower direction on an inner side face of the protruded part 25e in the radial direction and an inner side face of the recessed part 25f in the radial direction) is referred to as a lower end side inner side face 25j, a width of the lower end side inner side face 25j in the circumferential direction is set to be wider than the width of the magneto-sensitive part 7a in the circumferential direction.

A chamfer part 25k is formed on an upper end face and at an inner side end in the radial direction of the positioning part 25d. In other words, the chamfer part 25k is formed at an inner side end in the radial direction of the upper end face of the protruded part 25e and at an inner side end in the radial direction of the upper end face of the portion of the positioning part 25d where the recessed part 25f is formed. Therefore, the inner side end in the radial direction of the upper end face of the positioning part 25d is formed to be an inclined face which is inclined toward an outer side in the radial direction as going to the upper side. In this embodiment, a chamfer part is also formed in a portion except the inner side end in the radial direction of the upper end face of the positioning part 25d.

As described above, the magneto-sensitive part 7a is oppositely disposed to the outer peripheral face of the drive magnet 15 through the partition 11a. Specifically, the magneto-sensitive part 7a is disposed between the cylindrical tube part 11b and the positioning part 25d in the radial direction. More specifically, the magneto-sensitive part 7a is disposed between an outer peripheral face of an upper end side of the cylindrical tube part 11b in a portion on a lower side with respect to the inclined face 11e and the lower end side inner side face 25j in the radial direction. Further, the magneto-sensitive part 7a is placed on an upper face of a tip end portion of the salient pole part 24b.

### (Fixing Method of Circuit Board)

FIGS. 4(A) and 4(B) are explanatory views showing a fixing method of the circuit board 6 to the partition 11a shown in FIG. 1.

The circuit board 6 in a state that the magnetic sensors 7 are mounted is fixed to the partition 11a of the partition member 11 in a state that the stator 5 has been attached. In a state before the circuit board 6 is fixed to the partition 11a, as shown in FIG. 4(A), the terminal 7b is slightly bent inward in the radial direction so that a lower end side (magneto-sensitive part 7a side) of the magnetic sensor 7 is disposed on an inner side in the radial direction with respect to an upper end side of the magnetic sensor 7 (upper end side of the terminal 7b mounted on the circuit board 6).

After that, the circuit board 6 is lowered from an upper side with respect to the partition member 11 in a state that the stator 5 has been attached until the circuit board 6 is positioned by the positioning protruded parts 11d and the protruded part 11h. When the circuit board 6 is going to be lowered, as shown by the solid line in FIG. 4(B), an inner side portion in the radial direction of the lower end face of the magneto-sensitive part 7a is contacted with the inclined face 11e of the partition 11a and the terminal 7b is elastically deformed so that the magneto-sensitive part 7a is moved to an outer side in the radial direction. The terminal 7b is elastically deformed to an outer side in the radial direction until a lower end of the magneto-sensitive part 7a is reached to the outer peripheral side of the cylindrical tube part 11b in a lower side portion with respect to the inclined face 11e (see two-dot chain line in FIG. 4(B)). The magneto-sensitive part 7a is urged to an inner side in the radial direction by the terminal 7b which is elastically deformed and is contacted with the outer peripheral face of the cylindrical tube part 11b. In other words, the magneto-sensitive part 7a is disposed in a state that no space is existed between the outer peripheral face of the cylindrical tube part 11b and the magneto-sensitive part 7a. That is to say, the terminal 7b urges the magneto-sensitive part 7a to an inner side in the radial direction, and the magneto-sensitive part 7a is contacted with the outer peripheral face of the cylindrical tube part 11b. Since the magneto-sensitive part 7a of the magnetic sensor 7 is contacted with the outer peripheral face of the cylindrical tube part 11b, a distance between the drive magnet and the magneto-sensitive part 7a can be reduced and the magnetic pole of the outer peripheral face of the drive magnet can be detected appropriately.

When the circuit board 6 has been lowered until the circuit board 6 is positioned by the positioning protruded parts 11d and the protruded part 11h, the magneto-sensitive part 7a is, as shown by the broken line in FIG. 4(B), disposed between the cylindrical tube part 11b and the lower end side inner peripheral face 25j in the radial direction. In this state, the circuit board 6 is fixed to the partition 11a by welding while heating and crushing tip end parts of the positioning protruded parts 11d and the protruded part 11h. Alternatively, the circuit board 6 is fixed to the partition 11a by a screw not shown or the like.

### Principal Effects in this Embodiment

As described above, in this embodiment, the upper end of the outer peripheral face of the partition 11a is formed with the taper-shaped inclined face 11e and, when the circuit board 6 in a state that the magnetic sensor 7 has been mounted is to be fixed to the partition 11a from an upper side, the magneto-sensitive part 7a of the magnetic sensor 7 is contacted with the inclined face 11e and is guided along the inclined face 11e to the lower side portion with respect to the inclined face 11e, which is the outer peripheral side of the cylindrical tube part 11b. Therefore, according to this embodiment, when the circuit board 6 on which the magnetic sensor 7 has been mounted is to be fixed to the partition 11a from an upper side, although the magnetic sensor 7 cannot be observed from the upper side, the magneto-sensitive part 7a can be smoothly guided to the outer peripheral side of the cylindrical tube part 11b by utilizing the inclined face 11e while preventing excessive bending of the terminal 7b of the magnetic sensor 7.

Further, in this embodiment, the inner side flange part 25a of the insulator 25 is formed with the positioning part 25d which restricts a position of the magneto-sensitive part 7a in the radial direction, and the magneto-sensitive part 7a is disposed between the cylindrical tube part 11b and the positioning part 25d in the radial direction. Therefore, according to this embodiment, the magneto-sensitive part 7a which is guided to the outer peripheral side of the cylindrical tube part 11b along the inclined face 11e can be positioned with a high degree of accuracy in the radial direction by the cylindrical tube part 11b and the positioning part 25d. Accordingly, in this embodiment, a relative positional accuracy in the radial direction between the magneto-sensitive part 7a oppositely disposed to the outer peripheral face of the drive magnet 15 through the partition 11a and the drive magnet 15 can be enhanced.

Further, in this embodiment, the magneto-sensitive part 7a is disposed between the cylindrical tube part 11b and the positioning part 25d in the radial direction and thus, in a case that a resin sealing member is filled in an inside of a space defined by the cylindrical tube part 11b, the outer tube part 11f, the bottom face part 11g and the cover 12, positional displacement of the magneto-sensitive part 7a when the resin sealing member is to be filled can be restrained.

In this embodiment, the chamfer part 25k is formed at an inner side end in the radial direction of an upper end face of the positioning part 25d. Further, in this embodiment, the chamfer part 7c is formed at an inner side end in the radial direction of a lower end face of the magneto-sensitive part 7a. Therefore, according to this embodiment, when the circuit board 6 on which the magnetic sensor 7 has been mounted is to be fixed to the partition 11a from an upper side, the magneto-sensitive part 7a is easily entered between the cylindrical tube part 11b and the positioning part 25d in the radial direction.

In this embodiment, a width in a circumferential direction of the inner side face 25g of the positioning part 25d is set to be wider than a width of the magneto-sensitive part 7a in the circumferential direction. Therefore, according to this embodiment, a relative position in the circumferential direction of the magneto-sensitive part 7a to the stator 5 can be shifted depending on characteristics or the like of the motor 3. Accordingly, in this embodiment, a common insulator 25 can be used in motors 3 whose characteristics are different from each other and, as a result, versatility of the insulator 25 can be enhanced. Further, in this embodiment, the inner side face 25g is formed in a curved surface shape whose shape when viewed in the upper and lower direction is a circular arc shape with the rotation center of the rotor 4 as a center of curvature. Therefore, even when a relative position in the circumferential direction of the magneto-sensitive part 7a to the stator 5 can be shifted, displacement of a relative position in the radial direction between the magneto-sensitive part 7a and the drive magnet 15 is restrained and a relative positional accuracy in the radial direction of the magneto-sensitive part 7a to the drive magnet 15 can be enhanced.

In this embodiment, the inner side flange part 25a is formed in a flat plate shape which is perpendicular to the radial direction. Therefore, according to this embodiment, in comparison with a case that the inner side flange part 25a is formed in a curved plate shape, the inner side flange part 25a can be formed easily. Further, in this embodiment, the positioning part 25d is provided with the protruded part 25e which is protruded from an inner side face in the radial direction of the inner side flange part 25a and thus, even when the inner side flange part 25a is formed in a flat plate shape, a position in the radial direction of the magneto-sensitive part 7a can be restricted by utilizing the protruded part 25e.

### OTHER EMBODIMENTS

Although the present invention has been shown and described with reference to a specific embodiment, various changes and modifications will be apparent to those skilled in the art from the teachings herein.

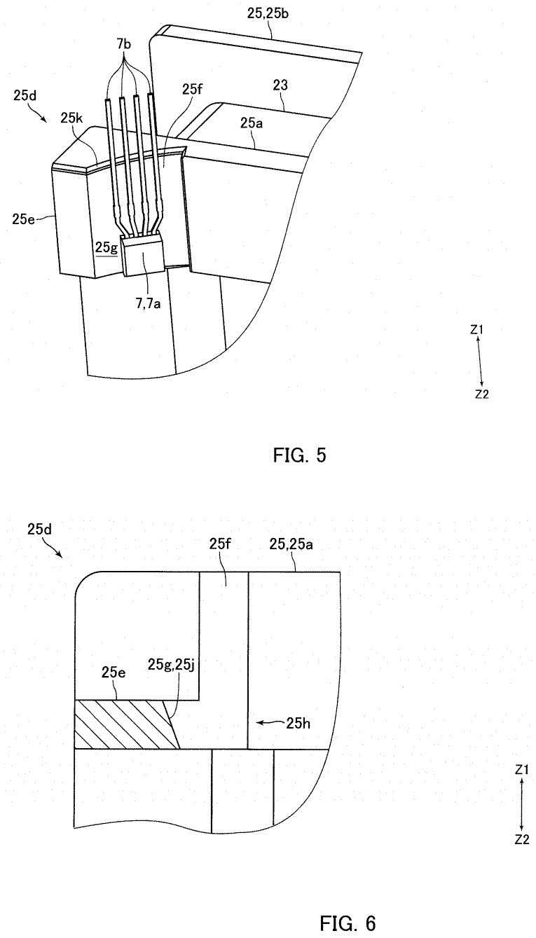

In the embodiment described above, the upper end face of the protruded part 25e is disposed on a lower side to the upper end face of the inner side flange part 25a. However, as shown in FIG. 5, an upper end face of the protruded part 25e may be disposed on the same plane as the upper end face of the inner side flange part 25a. Further, in the embodiment described above, the inner side face 25g of the positioning part 25d is formed to be a perpendicular plane which is not inclined to the upper and lower direction. However, the inner side face 25g may be, as shown in FIG. 6, formed in an inclined face which is inclined to an inner side in the radial direction as going to a lower side. In this case, when the circuit board 6 on which the magnetic sensor 7 has been mounted is to be fixed to the partition 11a from an upper side, the magneto-sensitive part 7a is easily entered between the cylindrical tube part 11b and the positioning part 25d in the radial direction. In FIG. 5 and FIG. 6, the same reference signs are used in the same structures as those in the embodiment described above.

In the embodiment described above, the inner side flange part 25a is formed in a flat plate shape which is perpendicular to the radial direction, and an outer side face in the radial direction of the inner side flange part 25a is formed in a flat face shape which is perpendicular to the radial direction. However, the outer side face in the radial direction of the inner side flange part 25a may be formed in a curved surface shape which is a circular arc shape with a rotation center of the rotor 4 as a center of curvature when viewed in the upper and lower direction. In this case, the positioning part 25d is not required to have the protruded part 25e. Further, in this case, no recessed part 25f may be formed in the positioning part 25d. Further, in the embodiment described above, a width in the circumferential direction of the inner side face 25g of the positioning part 25d is set to be wider than a width in the circumferential direction of the magneto-sensitive part 7a. However, a width in the circumferential direction of the inner side face 25g may be equal to a width in the circumferential direction of the magneto-sensitive part 7a.

In the embodiment described above, the stator core 24 is provided with three salient pole parts 24b. However, the number of the salient pole parts 24b of the stator core 24 may be four or more. In this case, when the number of the salient pole parts 24b provided in the stator core 24 is increased, a distance between adjacent salient pole parts 24b in the circumferential direction is narrowed and thus, a position of the magneto-sensitive part 7a is easily and automatically determined in the circumferential direction and the radial direction. On the other hand, when the number of the salient pole parts 24b is three like the embodiment described above, a distance in the circumferential direction between adjacent salient pole parts 24b is widened, the magneto-sensitive part 7a is hard to be automatically determined in the circumferential direction and the radial direction. Therefore, the positioning part 25d functions further effectively in a case that the number of the salient pole parts 24b is smaller.

In the embodiment described above, the magneto-sensitive part 7a is placed on the upper face of the tip end portion of the salient pole part 24b. However, a protruded part on which the magneto-sensitive part 7a is placed may be formed on an inner side face in the radial direction of the inner side flange part 25a. Further, in the embodiment described above, it may be structured that the inner side face 25g of the positioning part 25d is formed with a protruded part which restricts a position of the magneto-sensitive part 7a in the circumferential direction. Further, in the embodiment described above, the motor 3 is used in the pump device 1. However, the motor 3 may be used other than the pump device 1.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor comprising a drive magnet;
a stator which comprises a drive coil and is disposed on an outer peripheral side with respect to the rotor;
a partition member comprising a partition in a substantially bottomed cylindrical tube shape which is disposed between the rotor and the stator;
a circuit board which is fixed to the partition on an outer side of the partition in an axial direction of the rotor; and
a magnetic sensor comprising a magneto-sensitive part which is oppositely disposed to an outer peripheral face of the drive magnet through the partition;
wherein, when a direction where the circuit board is disposed with respect to the partition in the axial direction is referred to as a first direction and an opposite direction to the first direction is referred to as a second direction,
the stator comprises:
an insulation member; and
a stator core comprising a plurality of salient pole parts, the drive coil being wound around each salient pole part of the plurality of salient pole parts through the insulation member;
the stator core comprises:
an outer peripheral ring part which is formed in a ring shape; and
the plurality of the salient pole parts which are protruded from the outer peripheral ring part to an inner side in a radial direction of the rotor;
the insulation member comprises an inner side flange part which structures an inner side portion in the radial direction of the insulation member;
the partition comprises a cylindrical tube part in a cylindrical tube shape which is disposed between the rotor and the stator, and a bottom part in a circular plate shape which closes a first direction end of the cylindrical tube part and to which the circuit board is fixed;
a first direction end of an outer peripheral face of the partition comprises an inclined face whose outer diameter is gradually decreased as going to a first direction side;
the inner side flange part comprises a positioning part which restricts a position of the magneto-sensitive part in the radial direction;
a terminal of the magnetic sensor is mounted on the circuit board so that the magneto-sensitive part is protruded from the circuit board to a second direction side; and
the magneto-sensitive part is disposed between the cylindrical tube part and the positioning part in the radial direction.

2. The motor according to claim 1, wherein a width in a circumferential direction of the rotor of an inner side face of the positioning part in the radial direction is set to be wider than a width of the magneto-sensitive part in the circumferential direction.

3. The motor according to claim 2, wherein the inner side face of the positioning part in the radial direction is formed in a curved surface shape whose shape when viewed in the axial direction is a circular arc shape with a rotation center of the rotor as a center of curvature.

4. The motor according to claim 1, wherein a chamfer part is formed at an inner side end in the radial direction of an end face on the first direction side of the positioning part.

5. The motor according to claim 1, wherein an inner side face of the positioning part in the radial direction is formed to be an inclined face which is inclined to an inner side in the radial direction as going to the second direction side.

6. The motor according to claim 1, wherein
the inner side flange part is formed in a flat plate shape which is perpendicular to the radial direction, and
the positioning part comprises a protruded part which is protruded from an inner side face in the radial direction of the inner side flange part.

7. The motor according to claim 6, wherein an end face on the first direction side of the protruded part is disposed on a same plane as an end face on the first direction side of the inner side flange part.

8. The motor according to claim 1, wherein a chamfer part is formed at an inner side end in the radial direction of an end face on the second direction side of the magneto-sensitive part.

9. The motor according to claim 1, wherein
the terminal urges the magneto-sensitive part to an inner side in the radial direction, and
the magneto-sensitive part is contacted with an outer peripheral face of the cylindrical tube part.

10. The motor according to claim 1, wherein the positioning part comprises a recessed part which is recessed from an inner side face in the radial direction of the inner side flange part.

11. The motor according to claim 1, wherein a face on the first direction side of the bottom part comprises a positioning protruded part configured to position the circuit board fixed to the partition member so as to be protruded to the first direction side.

12. The motor according to claim 9, wherein
the partition member comprises an outer tube part in a tube shape disposed on an outer peripheral side with respect to the partition and a bottom face part which connects a lower end of the cylindrical tube part and a lower end of the outer tube part,
the bottom face part comprises a columnar protruded part which is stood up to an upper side, and
a circuit board positioning part configured to position the circuit board together with the positioning protruded part is formed on a tip end part side of the protruded part.

13. The motor according to claim 1, wherein
the stator core comprises three pieces of the salient pole parts,
the three salient pole parts are formed at equal angular pitches and are disposed at equal intervals in a circumferential direction,
the stator comprises:
three pieces of the insulation member each of which is attached to each of the three salient pole parts; and
three pieces of the drive coil each of which is wound around each of the three salient pole parts through each of the three insulation members,
the three insulation members comprise three pieces of the inner side flange part each of which is formed in each of the three insulation members,
the three inner side flange parts comprise three pieces of the positioning part each of which is formed in each of the three inner side flange parts, and
the three positioning parts comprise three pieces of the magnetic sensor each of which is disposed in each of the three positioning parts.

14. A pump device comprising:
the motor according to claim 1; and
an impeller which is attached to the rotor;
wherein a part of a pump chamber where the impeller is disposed and a fluid is passed through is defined by the partition member.

15. The motor according to claim 9, wherein
the inclined face is a guide face which is continuously formed with the cylindrical tube part on the first direction side of the cylindrical tube part so as to guide the magneto-sensitive part to the cylindrical tube part, and
the terminal is elastically deformed to an outer side in the radial direction because the magneto-sensitive part is guided by the inclined face so that the magneto-sensitive part is urged to and contacted with the outer peripheral face of the cylindrical tube part.

16. The motor according to claim 15, wherein
the inner side flange part is formed in a flat plate shape which is perpendicular to the radial direction, and
the positioning part comprises a protruded part which is protruded from an inner side face in the radial direction of the inner side flange part.

17. The motor according to claim 16, wherein a width in a circumferential direction of the rotor of an inner side face of the positioning part in the radial direction is set to be wider than a width of the magneto-sensitive part in the circumferential direction.

18. The pump device according to claim 14, wherein the pump chamber is provided on the second direction side with respect to the partition.

19. The pump device according to claim 14, wherein a width in a circumferential direction of the rotor of an inner side face of the positioning part in the radial direction is set to be wider than a width of the magneto-sensitive part in the circumferential direction.

20. The pump device according to claim 14, wherein
the inner side flange part is formed in a flat plate shape which is perpendicular to the radial direction, and
the positioning part comprises a protruded part which is protruded from an inner side face in the radial direction of the inner side flange part.

21. The pump device according to claim 14, wherein
the terminal urges the magneto-sensitive part to an inner side in the radial direction, and
the magneto-sensitive part is contacted with an outer peripheral face of the cylindrical tube part.

22. The pump device according to claim 21, wherein
the inclined face is a guide face which is continuously formed with the cylindrical tube part on the first direction side of the cylindrical tube part so as to guide the magneto-sensitive part to the cylindrical tube part, and
the terminal is elastically deformed to an outer side in the radial direction because the magneto-sensitive part is guided by the inclined face so that the magneto-sensitive part is urged to and contacted with the outer peripheral face of the cylindrical tube part.

23. The pump device according to claim 14, wherein the positioning part comprises a recessed part which is recessed from an inner side face in the radial direction of the inner side flange part.

24. The pump device according to claim 14, wherein a face on the first direction side of the bottom part comprises a positioning protruded part configured to position the circuit board fixed to the partition member so as to be protruded to the first direction side.

25. The pump device according to claim 14, wherein
the stator core comprises three pieces of the salient pole parts,
the three salient pole parts are formed at equal angular pitches and are disposed at equal intervals in a circumferential direction,
the stator comprises:
three pieces of the insulation member each of which is attached to each of the three salient pole parts; and
three pieces of the drive coil each of which is wound around each of the three salient pole parts through each of the three insulation members,
the three insulation members comprise three pieces of the inner side flange part each of which is formed in each of the three insulation members,
the three inner side flange parts comprise three pieces of the positioning part each of which is formed in each of the three inner side flange parts, and
the three positioning parts comprise three pieces of the magnetic sensor each of which is disposed in each of the three positioning parts.
